(19) United States
(12) Patent Application Publication
(10) Pub. No.: US 2022/0219571 A1
(43) Pub. Date: Jul. 14, 2022

(54) SYSTEMS AND METHODS FOR OCCUPANT CLASSIFICATION

(71) Applicants: Hanlong YANG, Novi, MI (US); James B. JOHNSON, Redford, MI (US); Bruno D. CARRARO, Ferndale, MI (US); Magna Seating Inc., Aurora (CA)

(72) Inventors: Hanlong Yang, Novi, MI (US); James Johnson, Redford, MI (US); Bruno Carraro, Ferndale, MI (US)

(21) Appl. No.: 17/610,029

(22) PCT Filed: May 8, 2020
(86) PCT No.: PCT/US2020/032014

§ 371 Date: Nov. 9, 2021

Related U.S. Application Data
(60) Provisional application No. 62/845,542, filed on May 9, 2019.

(51) Int. Cl. B60N 2/02; B60N 2/00; G07C 5/10; G07C 5/08; G07C 5/02; G06N 7/00

(52) U.S. Cl. CPC B60N 2/0244; B60N 2/002; G07C 5/10; B60N 2002/0268; G07C 5/02; G06N 7/005; B60N 2002/026; G07C 5/0808

(57) ABSTRACT

An occupant classification system for a seat assembly. The seat assembly includes a seat cushion and a seat back. The system comprises a plurality of sensors, an algorithm, a posture classifier and a weight classification system. Each of the plurality of sensors measures a force applied to the seat cushion and/or seat back by an occupant of the seat assembly. The algorithm monitors a compensation factor and adjusts the forces measured by the plurality of sensors to compensate for the compensation factor. The posture classifier identifies a posture of the occupant based on distribution of the adjusted forces for each of the plurality of sensors. The weight classification system identifies a weight class of the occupant based on the posture and magnitude of the adjusted forces for each of the plurality of sensors.

### CROSS-REFERENCE TO RELATED APPLICATIONS

This application claims priority to U.S. provisional patent application No. 62/845,542, filed May 9, 2019, which is incorporated herein by reference. Application No. PCT/US2019/042167, filed Jul. 17, 2019, also is incorporated herein by reference.

### TECHNICAL FIELD

The present invention relates to an occupant weight and posture classification system for a seat assembly in an automotive vehicle.

### BACKGROUND OF THE INVENTION

Automotive vehicles include one or more seat assemblies having a seat cushion and a seat back for supporting a passenger or occupant above a vehicle floor. The seat assembly is commonly mounted to the vehicle floor by a riser assembly. The seat back is typically operatively coupled to the seat cushion by a recliner assembly for providing selective pivotal adjustment of the seat back relative to the seat cushion.

Front passenger seat assemblies for automotive vehicles typically include an occupant classification system for determining the weight class of an occupant in the seat assembly. Occupant classification systems are useful to optimize vehicle safety systems, such as airbag deployment systems. For example, an occupant classification system may send the weight class information of an occupant to an occupant restraint controller, which may alter the intensity and the expansion rate of the energy-absorbing surface at which an airbag deploys depending on the weight of the occupant. For smaller individuals, the airbag may deploy at a lower intensity or not deploy at all.

Occupant classification systems typically include a pressure sensing device, such as a plurality of sensing cells or a bladder system, located in the seat cushion, which determines the weight of an occupant by measuring the amount of force applied to the seat cushion. However, the amount of force applied to the seat cushion varies depending on the occupant's posture because the occupant's posture affects the weight distribution between the vehicle floor, the seat cushion and the seat back. In addition, each occupant has a distinct manner of sitting that may affect their weight distribution on the seat. The types of cushion may affect the weight distribution as well due to variations in cushion materials and thickness.

For example, the amount of force measured on a seat cushion for a person sitting upright with their feet on the floor and their lower legs extended as depicted in FIG. 1A may be 49.8 kg. If that same individual leans forward as depicted in FIG. 1B, the amount of force decreases to 29.7 kg. Similarly, the amount of force measured on a seat cushion for a person sitting upright with their feet on the floor and their lower legs extended as depicted in FIG. 2A may be 36.9 kg, but when the individual raises his/her legs as depicted in FIG. 2B, the amount of force increases to 40.5 kg.

Conventional occupant classification systems often misclassify the weight of seat occupants because they do not distinguish between different sitting postures, which can greatly affect the accuracy of the weight measurements. It is desirable, therefore, to provide an occupant classification system that factors an occupant's posture into the weight analysis.

### SUMMARY OF THE INVENTION

Sensor measurements may be affected by various external and internal factors such as temperature and/or humidity variations, sensor age, sensor degradation, and road conditions. The present invention proposes various algorithms to compensate for these factors.

According to one embodiment, there is provided an occupant classification system for a seat assembly. The seat assembly includes a seat cushion and a seat back. The system comprises a plurality of sensors, an algorithm, a posture classifier and a weight classification system. Each of the plurality of sensors measures a force applied to the seat cushion and/or seat back by an occupant of the seat assembly. The algorithm monitors a compensation factor and adjusts the forces measured by the plurality of sensors to compensate for the compensation factor. The posture classifier identifies a posture of the occupant based on distribution of the adjusted forces for each of the plurality of sensors. The weight classification system identifies a weight class of the occupant based on the posture and magnitude of the adjusted forces for each of the plurality of sensors.

According to another embodiment, there is provided an occupant classification system for a seat assembly. The seat assembly includes a seat cushion and a seat back. The system comprises a plurality of sensors, a posture classifier, an algorithm and a weight classification system. Each of the plurality of sensors measures a force applied to the seat cushion and/or seat back by an occupant of the seat assembly. The posture classifier identifies a posture of the occupant based on distribution of the forces for each of the plurality of sensors. The algorithm monitors a road condition indicator and adjusts the posture identified by the posture classifier to compensate for the road condition indicator. The weight classification system identifies a weight class of the occupant based on the adjusted posture and magnitude of the forces for each of the plurality of sensors.

According to another embodiment, there is provided a method associated with classifying an occupant of a seat assembly. The seat assembly includes a seat cushion and a seat back. The method comprises the steps of measuring a plurality of forces applied by the occupant to the seat cushion and/or seat back, monitoring a compensation factor, adjusting the plurality of forces to compensate for the compensation factor, using the adjusted plurality of forces to identify a posture of the occupant, and using the posture and the adjusted plurality of forces to identify a weight class of the occupant.

According to another embodiment, there is provided a method associated with classifying an occupant of a seat assembly. The seat assembly includes a seat cushion and a seat back. The method comprises the steps of measuring a plurality of forces applied by the occupant to the seat cushion and/or seat back, using the plurality of forces to identify a posture of the occupant, monitoring a road condition indicator, adjusting the posture to compensate for the road condition indicator, and using the adjusted posture and the plurality of forces to identify a weight class of the occupant.

According to another embodiment, there is provided a method for deriving an occupant classification system for a seat assembly. The seat assembly includes a seat cushion and a seat back. The method comprises the steps of using a probabilistic method to train a posture classifier to differentiate between a plurality of postures, and for each of the plurality of postures, training a weight classification system to identify one of a plurality of weight classes. The step of training the weight classification system comprises the steps of using a deterministic method to derive a transfer function modeling a measurement of weight class as a function of actual weights and increasing a slope of the transfer function to optimize the measurement of the weight class.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1A is a perspective view of a person sitting on a seat assembly in one posture;

FIG. 1B is a perspective view of the person in FIG. 1A sitting on the seat assembly in a second posture;

FIG. 2A is a perspective view of another person sitting on a seat assembly in one posture;

FIG. 2B is a perspective view of the person in FIG. 2A sitting on the seat assembly in a second posture;

FIG. 3 is a perspective view of a seat assembly for an automotive vehicle;

FIG. 4 is a chart identifying potential postures;

FIG. 5 depicts an occupant classification system in accordance with the present invention;

FIG. 6 is a graph illustrating the weight class ranges for four different weight classes for all postures collectively;

FIG. 7 is a flow diagram of an occupant classification system in accordance with a second embodiment of the present invention;

FIG. 8 is a flow diagram of an occupant classification system in accordance with a third embodiment of the present invention;

FIG. 9 is a flow diagram of an occupant classification system in accordance with a fourth embodiment of the present invention;

FIG. 10 is a flow diagram of an occupant classification system in accordance with a fifth embodiment of the present invention;

FIG. 11 illustrates a sensor optimization algorithm to optimize weight classification detection in accordance with one embodiment of the present invention;

FIG. 12 illustrates a sensor optimization algorithm to optimize weight classification detection in accordance with another embodiment of the present invention; and

FIG. 13 illustrates a sensor optimization algorithm to optimize weight classification detection in accordance with another embodiment of the present invention.

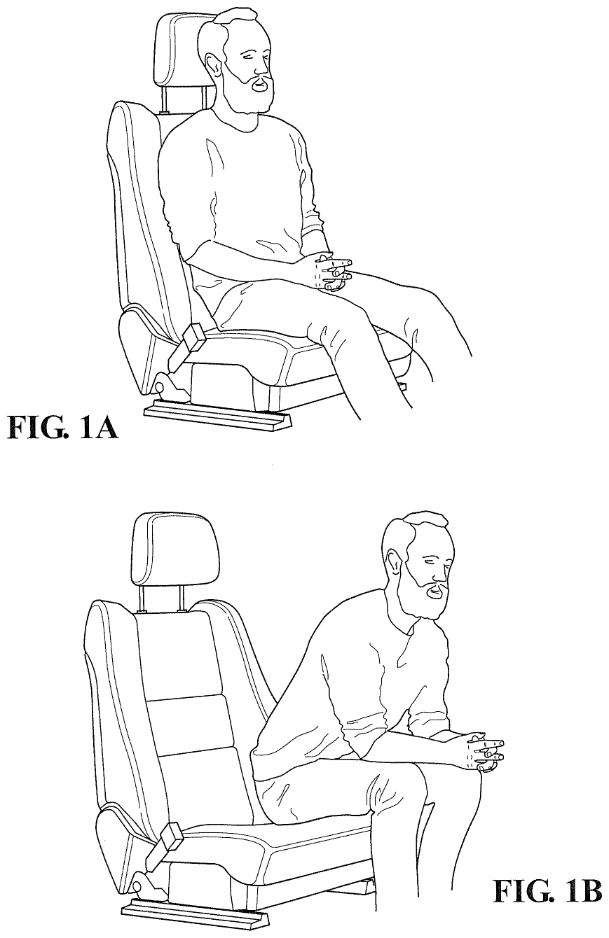

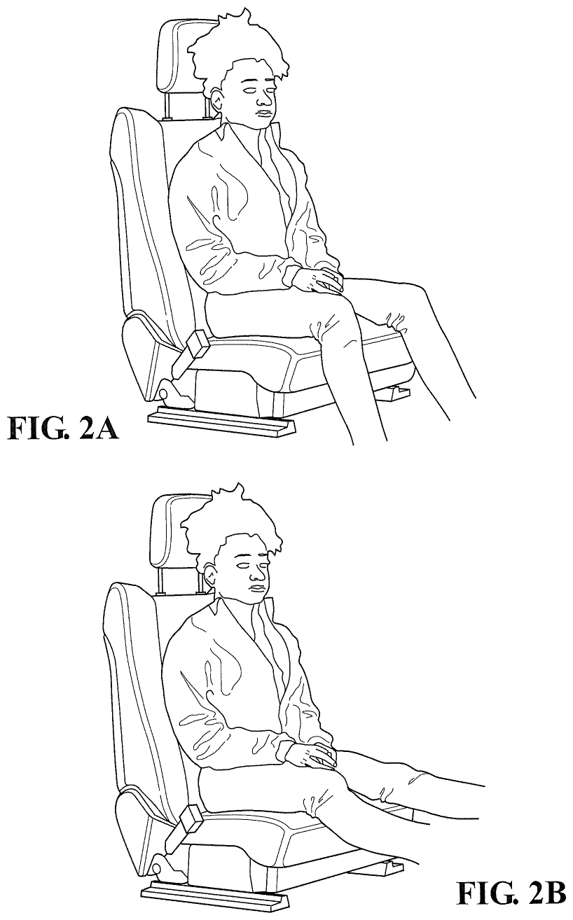

### DETAILED DESCRIPTION OF EXAMPLE EMBODIMENTS

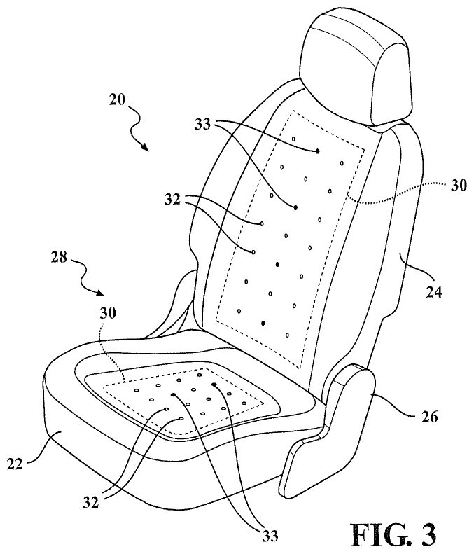

FIG. 3 illustrates one embodiment of a seat assembly 20 for use in an automotive vehicle. The seat assembly 20 includes a seat cushion 22 and a seat back 24 operatively coupled to the seat cushion 22 for supporting a seat occupant in a generally upright seating position. The seat back 24 is typically operatively coupled to the seat cushion 22 by a recliner assembly 26 for providing pivotal movement between an upright seating position and a plurality of reclined seating positions.

The seat assembly 20 includes an occupant classification system 28 for determining the posture 34 and the weight class 36 of an occupant in the seat assembly 20. Rather than trying to identify the precise weight of an occupant, the occupant classification system 28 of the present invention identifies the likelihood that the occupant belongs to a certain weight class. For example, the system 28 may distinguish between four standard adult weight classes: feather weight, light weight, middle weight and heavy weight. Feather weight is defined as an adult that falls below the 5^{th} percentile. Light weight is defined as an adult between the 5^{th} and 50^{th} percentile. Middle weight is defined as an adult between the 50^{th} and 95^{th} percentile. Heavy weight is defined as an adult above the 95^{th} percentile.

Conventional occupant classification systems commonly mistake child seats for adults because the weight measured on a seat cushion and/or seat back includes not only the weight of the child seat and the weight of a child in the child seat, but also may be affected by seat belt tension. The present invention solves this problem by treating a child seat as a posture 34. Once categorized as a posture 34, the system 28 may distinguish between different child seat weight classes 36. For example, the system 28 may distinguish between a 12-month old, a 3-year old and a 6-year old.

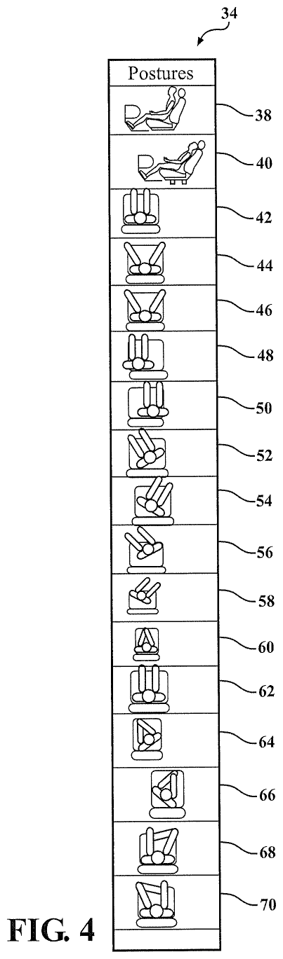

In addition to a child seat, the system 28 may distinguish between any number of postures 34. For example, referring to FIG. 4, the system 28 may distinguish between a person sitting upright with their feet on the floor and their lower legs extended 38, a person sitting in a slouched position 40, a person sitting upright with their feet on the floor and their lower legs pulled in toward the seat 42, a person sitting with their legs spread apart with their feet on the floor and their lower legs pulled in toward the seat 44, a person sitting with their legs spread apart with their feet on the floor and their lower legs extended 46, a person sitting on the left side of the seat with their lower legs pulled in toward the seat 48, a person sitting on the right side of the seat with their lower legs pulled in toward the seat 50, a person sitting with their legs angled to the left 52, a person sitting with their legs angled to the right 54, a person sitting on the front edge of the seat with their legs angled to the left 56, a person sitting on the front edge of the seat with their legs angled to the right 58, a person sitting with their legs crossed 60, a person sitting with their hands beneath their thighs 62, a person sitting with their legs crossed and angled to the left 64, a person sitting with their legs crossed and angled to the right 66, a person sitting with their right foot tucked under their left thigh 68, and a person sitting with their left foot tucked under their right thigh 70. The occupant classification system 28 of the present invention may be trained to identify additional postures 34, and is thus not limited to the postures 34 identified in FIG. 4.

The occupant classification system 28 may be used to optimize vehicle safety systems, such as an airbag deployment system. For example, the occupant classification system 28 may provide the posture 34 of the occupant to an occupant restraint controller so that the occupant restraint controller will not deploy an airbag under certain conditions, such as if there is a child seat in the seat assembly 20 or if the occupant is sitting in a vulnerable position that is not ideal for airbag deployment. The occupant classification system 28 may also provide the weight class 36 of the occupant to the occupant restraint controller so that the occupant restraint controller may alter the intensity and the airbag energy-absorbing surface expansion rate at which the airbag deploys. For example, for feather weight individuals, the occupant restraint controller may deploy the airbag at a lower energy release intensity.

Referring to FIG. 3, the occupant classification system 28 of the present invention includes an array 30 of sensing cells 32 in the seat cushion 22. Each sensing cell 32 measures the amount of force applied to the cell 32. In a preferred embodiment, the system 28 also includes an array 30 of sensing cells 32 in the seat back 24. Including the sensing cells 32 in both the seat cushion 22 and the seat back 24 increases overall performance of the system 28. The seat cushion 22 and seat back 24 also may include thermistors 33 to calibrate various characteristics of the sensor cells 32 due to temperature variation, as discussed below. Although the seat cushion 22 is depicted as including 4 rows of 4 sensing cells, and the seat back 24 is depicted as including 7 rows of 3 sensing cells, the number of sensing cells 32 in each array 30 is customizable.

Each sensing cell 32 provides a voltage based on the magnitude of force applied to each individual sensing cell 32. After filtering the voltage, an analog-to-digital converter (“ADC”) converts the voltage into a digital signal, preferably a digital signal with at least 10-bits to ensure high resolution of the measurement. The dynamic range of reliable force measured on each sensing cell 32 may vary between 0 and 500 grams. Alternatively, the dynamic range may include any range that is capable of detecting heavy weight classes. The system 28 may output an array 30 of values 400 times per second.

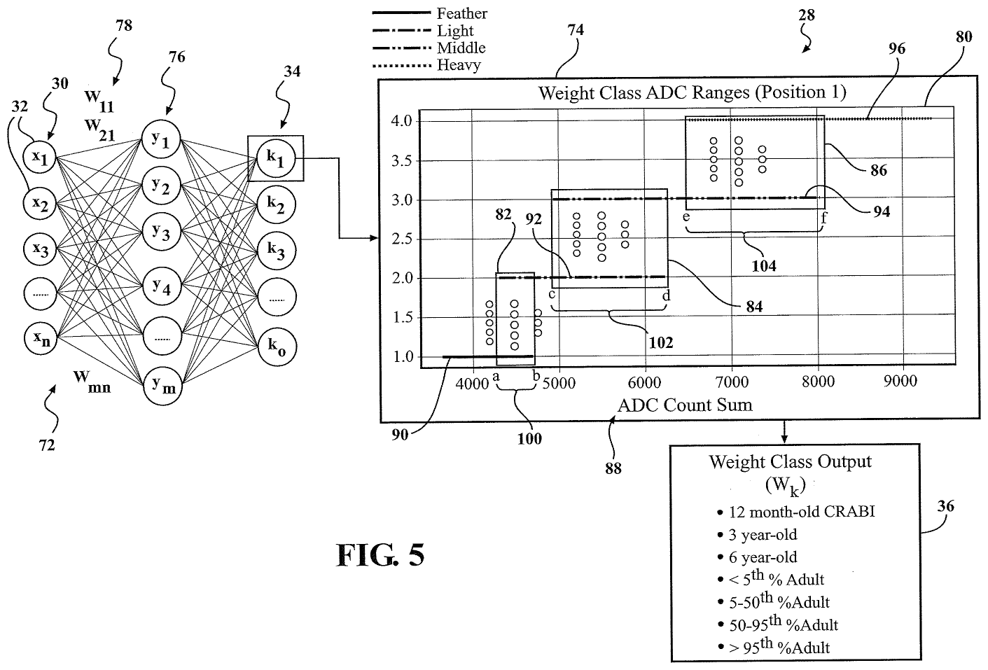

Referring to FIG. 5, the occupant classification system 28 of the present invention also includes a posture classifier 72 and a plurality of weight classifier systems 74. Each posture 34 corresponds to a unique weight classifier system 74. The posture classifier 72 determines the posture 34 of the occupant in the seat assembly 20 based on the distribution of forces on the array 30 of sensing cells 32. After determining the occupant's posture 34, the corresponding weight classifier system 74 determines the weight class 36 of the occupant based on the magnitude of force on each sensing cell 32 in the array 30.

The posture classifier 72 may comprise a deterministic model or a probabilistic model, i.e., a properly trained machine learning model based on a labeled dataset (e.g., the actual postures used to train the model). Preferably, the posture classifier 72 comprises a probabilistic model. A probabilistic model is preferred over a deterministic model because it allows for more significant handling of output ambiguities, it is quicker to develop, and it is more easily adapted and scaled. Because it uses a multiple signal input array 30, a probabilistic model also more easily accommodates different seat cushion types, complex user types, and even occupant behaviors. In other words, it uses a higher dimensional analysis (i.e., spatial 3D sensing) and nonlinear functions compared to a one-dimensional deterministic linear model.

Preferably, the probabilistic model comprises a neural network or a deep machine learning model with more sophisticated structures of neuron layers and weights functions. However, other probabilistic models may be used, including support vector machines, logistic regression, decision trees, Naïve-Bayes or nearest neighbors. The posture classifier 72 depicted in FIG. 5 comprises a typical neural network. Various algorithms based on different types of optimizations and architectures may be used to train the neural network to differentiate between the different postures 34. For example, a supervised batch learning method may be used to adjust the weights and bias parameters that feed every node of the neural network and regulate its output. Although probabilistic in nature, once the weights and bias terms have been optimized during the learning process, the system becomes deterministic. In other words, it becomes predicable once it receives a different set of data.

The input layer of the posture classifier 72 comprises the array 30 of sensing cells 32 (X=[x₁, x₂, . . . xₙ]), where n represents the number of sensing cells 32. The output layer of the posture classifier 72 comprises the different postures 34 [k₁, k₂, . . . kₒ] that the system has been trained to recognize. The posture classifier 72 includes a hidden layer with m transfer functions 76 [y₁, y₂, . . . yₘ], where the weights 78 of the transfer functions 76 are represented by [w₁₁, w₂₁, . . . wₘₙ]. Although depicted with a single hidden layer, the type and structure of the neural network may be modified to optimize the system, for example by using more than one hidden layer or by changing the number of nodes in the hidden layer.

The weight classifier system 74 may comprise a deterministic model or a probabilistic model. Preferably, the weight classifier system 74 includes a deterministic component 80 and a plurality of probabilistic components 82, 84, 86. For example, the deterministic component 80 may comprise a weight band based on the total sum 88 of the values (ADC counts) from the sensing cells 32 for each weight class 36. As depicted in the example in FIG. 5, for a given posture, the feather weight band 90 extends from below 4000 to b, the light weight band 92 extends from a to d, the middle weight band 94 extends from c to f, and the heavy weight band 96 extends from e to over 9000.

There may be an overlap between adjacent weight bands 90, 92, 94, 96. For the example depicted in FIG. 5, the overlap 100 between the feather weight band 90 and the light weight band 92 occurs when the total sum 88 of the values from the sensing cells 32 falls between a and b. The overlap 102 between the light weight band 92 and the middle weight band 94 occurs when the total sum 88 of the values from the sensing cells 32 falls between c and d. The overlap 104 between the middle weight band 94 and the heavy weight band 96 occurs when the total sum 88 of the values from the sensing cells 32 falls between e and f.

Threshold values may be identified for each weight class in which the total sum 88 of the values from the sensing cells 32 could only reflect one weight class and no other because between or beyond these threshold values, there is no overlap with an adjacent class. For example, if the total sum 88 of the values from the sensing cells 32 is less than a, then the occupant is a feather weight. If the total sum 88 of the values from the sensing cells 32 falls between b and c, then the occupant is a light weight. If the total sum 88 of the values from the sensing cells 32 falls between d and e, then the occupant is a middle weight. And if the total sum 88 of the values from the sensing cells 32 is greater than f, then the occupant is a heavy weight.

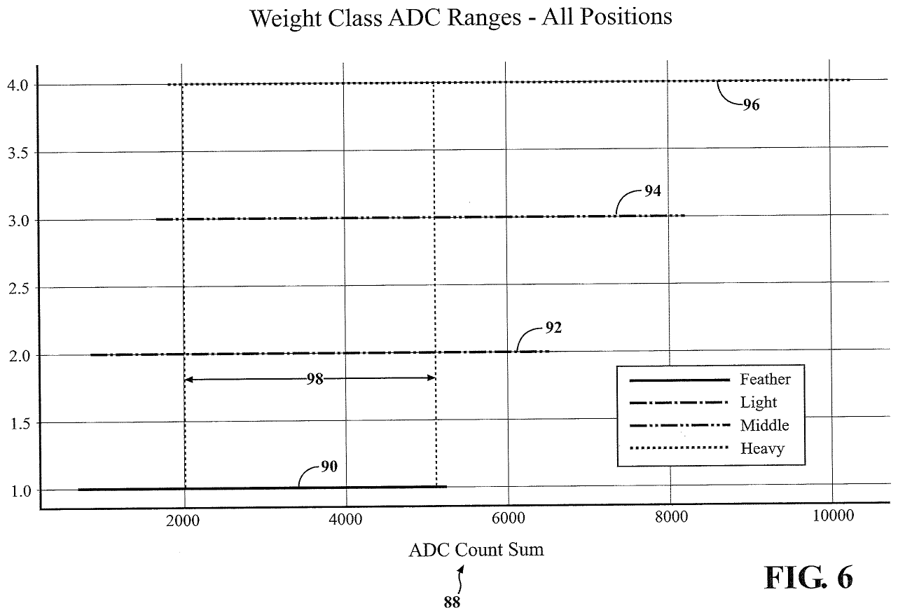

FIG. 6 illustrates the importance of factoring posture 34 into determining weight classification. If one were to compare the total sum 88 of the values from the sensing cells 32 for all postures 34 collectively, the weight bands 90, 92, 94, 96 for each weight class 36 will expand because for any given individual, the sensor readings in the different postures 34 may vary significantly. The greater variation in individual sensor readings results in a wider weight band 90, 92, 94, 96 for all individuals within that weight band 90, 92, 94, 96, and a greater likelihood of overlap between different weight bands 90, 92, 94, 96. Thus, as depicted, there is an area of overlap 98, not only between adjacent weight classes 36, but between all four weight classes. By contrast, viewing the sensor readings on a posture-by-posture basis, as illustrated by the deterministic component 80 in FIG. 5, fine-tunes the weight class bands 90, 92, 94, 96 in such a way that overlap is reduced and limited to adjacent weight classes 36. Thus, the posture 34 information used in the weight classification algorithm improves the separation between different weight classes 36.

Returning to FIG. 5, if the total sum 88 of the values from the sensing cells 32 falls within overlap 100, then probabilistic component 82 may be used to distinguish between the feather and light weight classes 36. If the total sum 88 of the values from the sensing cells 32 falls within overlap 102, then probabilistic component 84 may be used to distinguish between the light and middle weight classes 36. If the total sum 88 of the values from the sensing cells 32 falls within overlap 104, then probabilistic component 86 may be used to distinguish between the middle and heavy weight classes 36.

Preferably, each probabilistic component 82, 84, 86 of the weight classifier system 74 comprises a neural network. However, other probabilistic models may be used, including support vector machines, logistic regression, decision trees, Naïve-Bayes, nearest neighbors, regression-based models or a radial basis network. Similar to the posture classifier 72, the probabilistic components 82, 84, 86 are trained with large and properly labeled datasets to differentiate between their respective adjacent weight classes 36.

Additional modifications may be made to improve the accuracy of the occupant classification system 28. For example, the system 28 may determine the centroid of the occupant and use it to enhance one or more of the probabilistic models 72, 82, 84, 86. The centroid also may be useful to identify transitions in postures 34 and to identify slight variations based on the occupant's specific manner of sitting.

The deterministic component 80 of the weight classifier system 74 may use metrics different from the total sum 88 of the values from the sensing cells 32 to identify the weight classes. For example, the deterministic component 80 may be based on the centroid of the occupant or the average of the values measured from the sensing cells 32. Likewise, these metrics may be used to enhance one or more of the probabilistic models 72, 82, 84, 86. The system 28 also may use the temperature of the sensing cells 32 to enhance one or more of the probabilistic models 72, 82, 84, 86.

There may be circumstances in which one or more of the probabilistic models 72, 82, 84, 86 may not be able to clearly identify a single posture 34 or weight class 36 into which an occupant falls. In these circumstances, the system 28 can apply a deterministic model and/or confirmed historical data to help distinguish which posture 34 or weight class 36 is most appropriate for this occupant.

The system 28 also may assign a greater degree of significance to some of the sensing cells 32 over the others. For example, the system 28 may double the value for the sensing cells 32 located near the occupant's center of gravity or decrease the value for the sensing cells 32 located closer to the bolsters of the seat cushion 22 and/or seat back 24 before they are input into the classification systems 72, 74.

To enhance and maintain the proper detection of postures 34 and weight classes 36, it is important to have accurate measurements for each sensing cell 32. Sensor measurements may be affected by various external and internal factors such as weather variations, road conditions, age of the sensors and proper functioning of the sensors. The present invention proposes various algorithms to compensate for such factors. Any combination of these algorithms may be implemented without departing from the scope of the present invention.

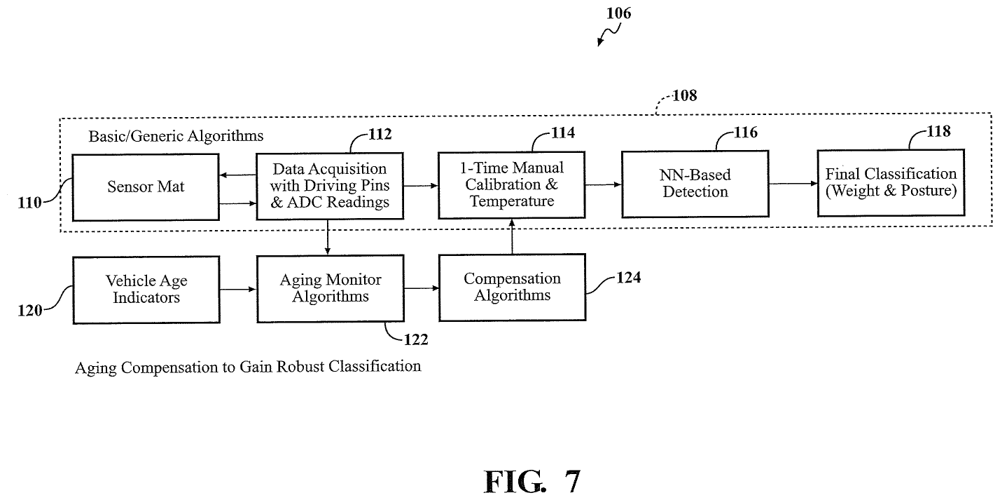

All sensors age over their useful life due to various factors, such as temperature, overheating, wear and tear, etc. As depicted in FIG. 7, the present invention includes an occupant classification algorithm 106 that monitors various vehicle age indicators 120, and adjusts the readings from the sensing cells 32 to compensate for the classification based on these vehicle age indicators 120. The occupant classification algorithm 106 includes the basic algorithm 108 for the occupant classification system 28 described above. Each sensing cell 32 from the sensor mat 110 (i.e., the array 30 of sensing cells 32) provides a voltage based on the magnitude of force applied to each individual sensing cell 32. The basic algorithm 108 acquires these voltages, and converts them into digital signals 112 with proper hardware filters. The data may then be processed with a one-time manual calibration and temperature adjustment 114, before it is provided to a neural network-based detection algorithm 116 to predict a final classification of weight and posture 118. The occupant classification algorithm 106 of the present invention is an improvement over the basic algorithm 108 because it includes aging monitor algorithms 122 and compensation algorithms 124 to provide robust classification detection with sensor aging compensation. The aging monitor algorithm 122 monitors various vehicle age indicators 120, such as ambient temperature, vehicle mileage, engine operating hours and related service information. The compensation algorithm 124 adjusts the data received from the sensor mat 110 to compensate for the vehicle age indicators 120. The one-time manual calibration and temperature algorithm 114 processes the age adjusted data, which is then fed into the neural network-based detection algorithm 116 to determine the final classification of weight and posture 118.

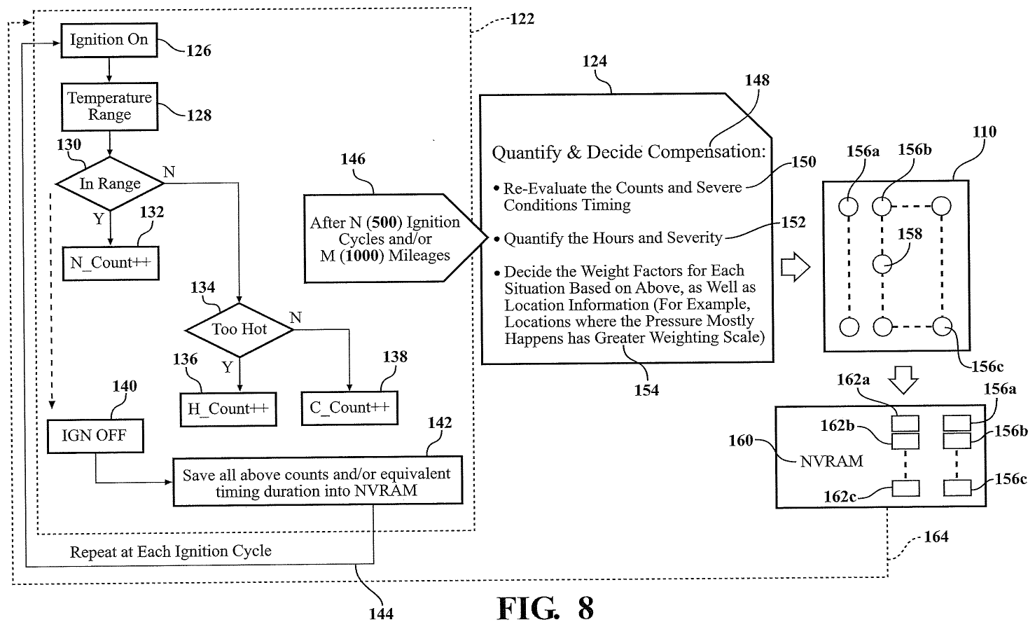

FIG. 8 illustrates one embodiment of an aging monitor algorithm 122 and compensation algorithm 124 that adjust for the system performance of weight classification based on vehicle age indicators 120. When the driver turns on the vehicle ignition 126, the aging monitor algorithm 122 begins measuring the ambient temperature 128 and determines whether the average ambient temperature during the ignition cycle is within a normal range 130. If it is within a normal range, the aging monitor algorithm 122 increases the normal count by one (N_Count++) 132. If the average ambient temperature 128 during the ignition cycle 126 is not within a normal range 130, the aging monitor algorithm 122 determines whether the average ambient temperature 128 during the ignition cycle 126 is too hot 134. If it is too hot 134, the aging monitor algorithm 122 increases the hot count by one (H_Count++) 136. If the average ambient temperature 128 during the ignition cycle 126 is not too hot 134, the aging monitor algorithm 122 increases the cold count by one (C_Count++) 138.

The aging monitor algorithm 122 may consider more than three temperature ranges, e.g., the aging monitor algorithm 122 may consider the effect of extreme temperature ranges on the sensing cells 32. The aging monitor algorithm 122 may also monitor the ambient temperature 128 while the vehicle is in motion, e.g., every 10 miles, and may record the duration during which the ignition is on. When the driver turns the ignition off 140, the aging monitor algorithm 122 saves all of the counts 132, 136, 138 and/or equivalent timing durations 142 into non-volatile random-access memory (“NVRAM”) 160. The occupant classification algorithm 106 repeats 144 the aging monitor algorithm 122 every time the ignition is turned on 126.

After every N (e.g., 500) ignition cycles and/or M (e.g., 1000) miles 146, the compensation algorithm 124 quantifies the recorded information and determines how to compensate 148 for the vehicle age indicators 120. The compensation algorithm 124 re-evaluates the counts and severe conditions timing 150, quantifies the hours and severity 152, and determines 154 the weight factors 162a, 162b, . . . 162c for each situation. The compensation algorithm 124 considers the locations 156a, 156b, . . . 156c of the sensing cell 32 on the sensor mat 110 so that the location 158 of the sensing cell 32 that frequently detects pressure has a greater weight factor than locations that are only periodically activated to detect pressure. The compensation algorithm 124 stores the weight factors 162a, 162b, . . . 162c into NVRAM 160. These weight factors 162a, 162b, . . . 162c are fed back 164 into and considered by the aging monitor algorithm 122 when analyzing the vehicle age indicators 120.

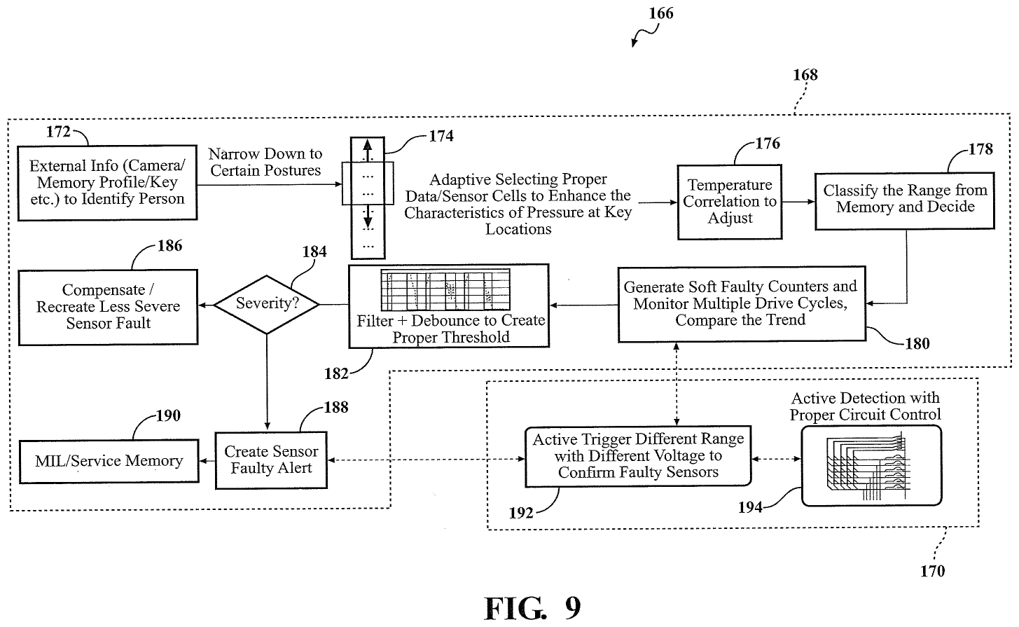

Referring to FIG. 9, the present invention includes an occupant classification system diagnostics algorithm 166 that monitors the signals from individual sensing cells 32 and adjusts the sensor data based on detected sensor drift and/or faulty sensor output. The diagnostics algorithm 166 includes base diagnostics 168 and a faulty alert adaptation 170. The base diagnostics 168 detects open and short circuits via direct measurements. The base diagnostics 168 may include external inputs 172 (e.g., a camera, memory profile or key) to identify the occupant in the seat assembly 20. The external input 172 also may be used to rule out certain postures and identify key sensing cell locations to monitor 174. The base diagnostics 168 adjusts the readings from the sensing cells 32 to compensate for ambient temperature 176 and retrieves the weight range for the identified passenger from memory 178. The base diagnostics 168 monitors multiple drive cycles 180 under different driving conditions to identify variations and characteristics in sensor readings. The base diagnostics 168 also compares the sensor reading characteristics over time to identify any trends in the sensor readings and to determine any changes to the trends over time 180. The base diagnostics 168 generates soft faulty counters 180 when it detects faulty sensors. The base diagnostics 168 filters and debounces the sensor readings to create a proper threshold for acceptable discrepancies 182, and uses the threshold to determine the severity of the sensor fault 184. If the base diagnostics 168 determines that the sensor fault is not severe, it compensates for the sensor fault or recreates a less severe sensor fault 186. If the base diagnostics 168 determines that the sensor fault is severe, then it creates a sensor faulty alert 188 and saves the information regarding the sensor fault in memory 190. The base diagnostics 168 also sends the information to a vehicle controller and notifies the driver to have the vehicle serviced by activating a malfunction indication lamp (“MIL”) 190. A severe sensor fault also triggers the faulty alert adaptation 170 to alter various operating conditions (e.g., the vehicle may use a different battery voltage if the battery voltage is found to be too low or too high), and rerun the base diagnostics 168 to confirm that the sensors are faulty 192. After running several base diagnostics 168 with different operating conditions, the faulty alert adaptation 170 determines the optimized operating conditions and continues to run the base diagnostics 168 using a proper circuit control 194.

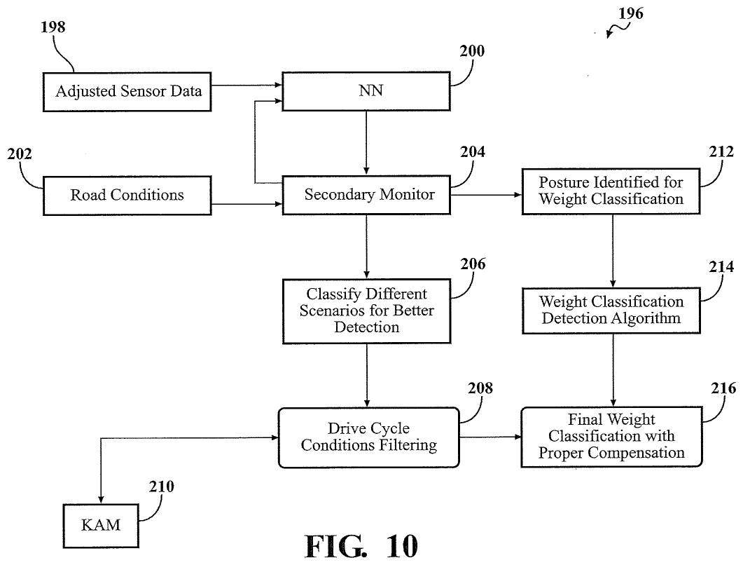

Referring to FIG. 10, the present invention includes a robust weight classification algorithm 196 that considers various road conditions 202 in determining the proper posture 34 and weight class 36 for the seat occupant. The present invention also compensates for various seat conditions that may affect sensor readings. For example, sensor accuracy may be affected by the height of the seat assembly 20, the firmness of the seat cushion 22, the firmness of the seat back 24, the type and tension of the seat cover, and the clothes of the occupant. The present invention adjusts the data from the sensor mat to compensate for these seat conditions before the adjusted sensor data 198 are provided to the neural network 200.

The robust weight classification algorithm 196 includes a secondary monitor 204 that compensates for road conditions 202, such as tilt, road vibration, vehicle speed and/or vehicle acceleration. The secondary monitor 204 considers short term road conditions (e.g., vehicle acceleration, deceleration, turns, particular driver's driving patterns, etc.) to classify different scenarios 206 for better posture and weight detection. For example, the secondary monitor 204 may detect when the vehicle is traveling on an incline and compensate for the sensor readings to reflect that although the weight distribution on the sensor mat 110 may change, the posture of the passenger does not. As another example, the secondary monitor 204 may detect when the vehicle is making a sharp turn and compensate for the sensor readings to reflect that when the vehicle is making the sharp turn, the passenger in the seat assembly 20 is likely compensating by leaning into the turn to avoid being thrown off by centrifugal forces. The secondary monitor 204 also considers the impact of long-term road conditions (e.g., whether the vehicle is on a highway, whether the vehicle is traveling for long distances, whether the road has a relatively high or low slope/grade, etc.) on the sensor readings in order to filter these drive cycle conditions 208 from the sensor readings. Both the classification of the different scenarios 206 and the drive cycle conditions 208 are stored in Keep-Alive Memory (“KAM”) 210 or in non-volatile random-access memory (“NVRAM”) 160. In addition, information from the secondary monitor 204 may be considered by the neural network 200 to account for the impact of the road conditions 202 on the adjusted sensor data 198.

The secondary monitor 204 adjusts the output from the neural network 200 to compensate for the road conditions 202 and identifies the posture 212 of the seat occupant. A weight classification detection algorithm 214 uses the posture identified for weight classification 212 to identify the weight classification of the seat occupant. The robust weight classification algorithm 196 uses the classification of the different scenarios 206 and the drive cycle conditions 208 to adjust the weight classification from the weight classification detection algorithm 214 and determine a final weight classification with proper compensation 216.

The secondary monitor 204 also may monitor in-cabin vibrations to determine the effects of the vibrations on vehicle passengers. If the seat vibrations are quite severe, the secondary monitor 204 may reflect the severity of the road conditions on the dashboard to remind the driver to avoid driving under such severe conditions. Alternatively, if the vehicle is equipped with active suspensions, the information from the secondary monitor 204 may be used to control the suspension to mitigate the effects of the vibrations.

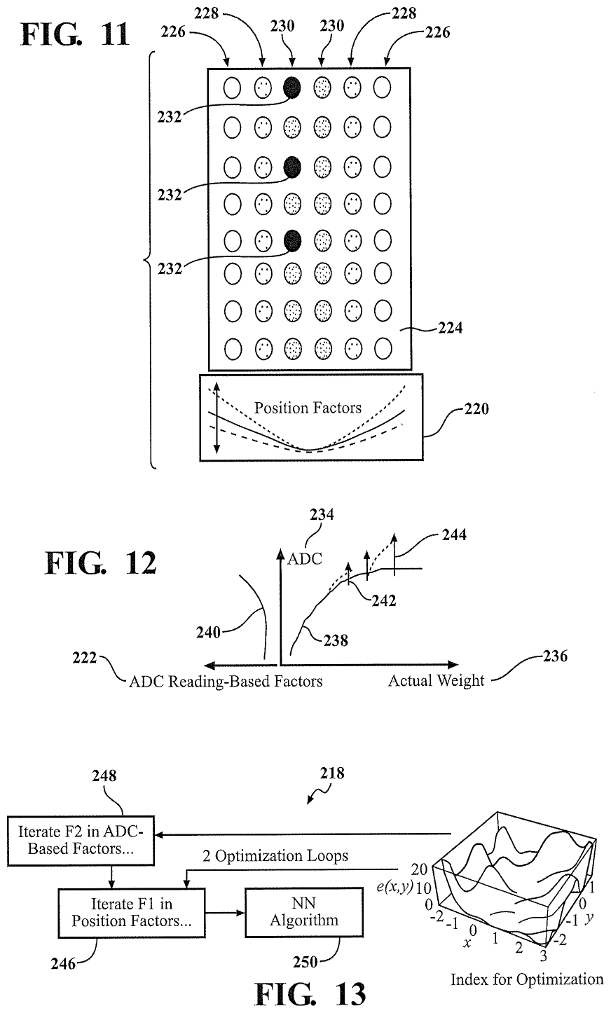

Referring to FIGS. 11-13, the present invention includes occupant classification training optimization algorithms 218 for improved machine learning results. Because of their smaller size, feather weight and light weight individuals are less likely than middle weight and heavy weight individuals to impact the sensing cells 32 on the outer columns 226 of the sensor mat 224. Thus, even slight readings on these sensing cells 32 are an important consideration when determining the weight class 36 of the seat occupant. In addition, as the actual weight 236 of the occupant increases, the ADC readings 234 (i.e., the values from the sensing cells 32) do not increase proportionally. Instead, small variations in ADC readings 234 lead to larger changes in actual weight 236. Thus, it is more difficult to distinguish between middle weight and heavy weight individuals. To account for these factors, the occupant classification training optimization algorithm 218 of the present invention adjusts both the position factors 220 and the ADC reading-based factors 222 to optimize the weight classification detection for each posture 34 while the neural network is being trained with labeled datasets.

FIG. 11 depicts a sensor mat 224 that includes a 6×8 grid of individual sensing cells 32. Because the number of sensing cells in the sensor mat 224 is customizable, the 6×8 configuration was selected for illustrative purposes only. The sensor mat 224 includes thermistors 232 to monitor the temperature of the sensor mat 224 and thus the temperature of the sensing cells 32 in the mat 224. The occupant classification training optimization algorithm 218 may assign different position factors 220 to the sensing cells 32 based on the position of the sensing cell 32 within the mat 224. Thus, sensing cells 32 in the first and sixth column (i.e., the “outer columns”) 226 may be assigned weight factors different from sensing cells 32 in the third and fourth columns (i.e., the “inner columns”) 230 or sensing cells 32 in the second and fifth columns (i.e., the “center columns”) 228. For example, the position factors 220 for the inner columns 230 may be lower than the position factors 220 for the center columns 228, which may be lower than the position factors 220 for the outer columns 226, as depicted in FIG. 11. Alternatively, the position factors 220 may increase from the inner columns 230 to the center columns 228, and then decrease for the outer columns 226. Thus, although depicted as a U-shaped curve, the position factors 220 may have other waveforms based on the specific sensor cell characteristics.

FIG. 12 depicts a transfer function 238 modeling the ADC readings 234 as a function of the actual weight 236 of the occupant. As the actual weight 236 of the occupant increases, the slope of the transfer function 238 decreases. To compensate for the saturation at the higher actual weight 236 values, the present invention increases the ADC reading-based factors 222 (i.e., the slope of the transfer function 238) as the ADC counts 234 increase (see graph 240). The increase in ADC reading-based factors 222 increases the ADC count 234 as depicted by arrow 242, which improves the resolution between weight classes (i.e., between middle weight and heavy weight classes) to optimize the weight classification detection. A further increase in ADC reading-based factors 222 increases the ADC count 234 as depicted by arrow 244, thus further improving the resolution between weight classes and optimizing the weight classification detection. Although amplifying the ADC count 234 improves the resolution between weight classes, it also amplifies the noise in the ADC count 234, which may increase the likelihood of incorrectly categorizing a weight class. Thus, during the training session, it is important to find the right ADC reading-based factor 222 to improve the resolution between weight classes without over-amplifying the noise through the proper optimization process.

Referring to FIG. 13, the occupant classification training optimization algorithm 218 runs multiple iterations 246 using different position factors 220 and multiple iterations 248 using different ADC reading-based factors 222 to identify the position factors 220 and ADC reading-based factors 222 that will optimize occupant weight and posture classification detection with the machine learning model, i.e., the neural network algorithm 250. In addition, the present invention may further optimize the position factors 220 and ADC reading-based factors 222 based on the vehicle age factors and/or the trends recorded for the sensing cells 32 over time.

The invention has been described in an illustrative manner, and it is to be understood that the terminology, which has been used, is intended to be in the nature of words of description rather than of limitation. Many modifications and variations of the present invention are possible in light of the above teachings. It is, therefore, to be understood that within the scope of the appended claims, the invention may be practiced other than as specifically described.

1. An occupant classification system for a seat assembly wherein the seat assembly includes a seat cushion and a seat back, the system comprising:
a plurality of sensors wherein each of the plurality of sensors measures a force applied to the seat cushion and/or seat back by an occupant of the seat assembly;
an algorithm for monitoring a compensation factor and adjusting the forces measured by the plurality of sensors to compensate for the compensation factor;
a posture classifier for identifying a posture of the occupant based on distribution of the adjusted forces for each of the plurality of sensors; and
a weight classification system for identifying a weight class of the occupant based on the posture and magnitude of the adjusted forces for each of the plurality of sensors.

2. The occupant classification system of claim 1 wherein the compensation factor comprises a vehicle age indicator.

3. The occupant classification system of claim 2 wherein the vehicle age indicator comprises one of ambient temperature, vehicle mileage, engine operating hours and vehicle service information.

4. The occupant classification system of claim 1 wherein the compensation factor comprises a faulty sensor indicator.

5. The occupant classification system of claim 4 wherein the faulty sensor indicator comprises one of an open circuit, a short circuit, a sensor drift and a faulty sensor output.

6. The occupant classification system of claim 5 wherein the algorithm identifies the occupant based on an external input and retrieves a stored weight range for the occupant from memory.

7. The occupant classification system of claim 6 wherein the external input comprises one of a camera, a memory profile and a key.

8. The occupant classification system of claim 4 wherein the algorithm monitors multiple drive cycles under different driving conditions to identify variations in the adjusted forces for each of the plurality of sensors.

9. The occupant classification system of claim 8 wherein the algorithm identifies trends in the adjusted forces for each of the plurality of sensors.

10. The occupant classification system of claim 9 wherein the algorithm determines changes to the trends over time.

11. The occupant classification system of claim 10 wherein the algorithm determines a severity of the faulty sensor indicator.

12. The occupant classification system of claim 1 wherein the compensation factor comprises a seat indicator.

13. The occupant classification system of claim 12 wherein the seat indicator comprises one of a seat height, a seat cushion firmness, a seat back firmness, a seat cover type, a seat cover tension and clothing of the occupant.

14. The occupant classification system of claim 13 wherein the algorithm monitors a road condition indicator, adjusts the posture identified by the posture classifier to compensate for the road condition indicator, and identifies an adjusted weight class of the occupant based on the adjusted posture.

15. The occupant classification system of claim 14 wherein the road condition indicator comprises one of tilt, road vibration, vehicle speed and vehicle acceleration.

16. An occupant classification system for a seat assembly wherein the seat assembly includes a seat cushion and a seat back, the system comprising:
a plurality of sensors wherein each of the plurality of sensors measures a force applied to the seat cushion and/or seat back by an occupant of the seat assembly;
a posture classifier for identifying a posture of the occupant based on distribution of the forces for each of the plurality of sensors;
an algorithm for monitoring a road condition indicator and adjusting the posture identified by the posture classifier to compensate for the road condition indicator; and
a weight classification system for identifying a weight class of the occupant based on the adjusted posture and magnitude of the forces for each of the plurality of sensors.

17. The occupant classification system of claim 16 wherein the algorithm adjusts the weight class of the occupant based on the road condition indicator.

18. The occupant classification system of claim 17 wherein the road condition indicator comprises one of tilt, road vibration, vehicle speed and vehicle acceleration.

19. A method associated with classifying an occupant of a seat assembly, wherein the seat assembly includes a seat cushion and a seat back, the method comprising the steps of:
measuring a plurality of forces applied by the occupant to the seat cushion and/or seat back;
monitoring a compensation factor;
adjusting the plurality of forces to compensate for the compensation factor;
using the adjusted plurality of forces to identify a posture of the occupant; and
using the posture and the adjusted plurality of forces to identify a weight class of the occupant.

20. A method associated with classifying an occupant of a seat assembly, wherein the seat assembly includes a seat cushion and a seat back, the method comprising the steps of:
measuring a plurality of forces applied by the occupant to the seat cushion and/or seat back;
using the plurality of forces to identify a posture of the occupant;
monitoring a road condition indicator;
adjusting the posture to compensate for the road condition indicator; and
using the adjusted posture and the plurality of forces to identify a weight class of the occupant.

21. The method of claim 20 further comprising the step of adjusting the weight class of the occupant based on the road condition indicator.

22. A method for deriving an occupant classification system for a seat assembly, wherein the seat assembly includes a seat cushion and a seat back, the method comprising the steps of:
using a probabilistic method to train a posture classifier to differentiate between a plurality of postures; and
for each of the plurality of postures, training a weight classification system to identify one of a plurality of weight classes, wherein the step of training the weight classification system comprises the steps of:
using a deterministic method to derive a transfer function modeling a measurement of weight class as a function of actual weights; and
increasing a slope of the transfer function to optimize the measurement of the weight class.

23. The method of claim 22 wherein the step of training the weight classification system further comprises the steps of:
measuring a plurality of forces applied to the seat cushion and/or seat back; and
adjusting a weight of one of the plurality of forces based on a location of the force on the seat cushion and/or seat back to optimize the weight classification system.

24. The method of claim 23 further comprising the steps of:
monitoring a compensation factor over time; and
using the compensation factor over time to adjust the slope of the transfer function to further optimize the measurement of the weight class.

25. The method of claim 24 further comprising the step of using the compensation factor over time to adjust the weight of the one of the plurality of forces to further optimize the weight classification system.
